(19) United States
(12) Patent Application Publication
(10) Pub. No.: US 2026/0277151 A1
(43) Pub. Date: Sep. 17, 2026

(54) IMAGE FORMING APPARATUS

(71) Applicant: KYOCERA Document Solutions Inc., Osaka (JP)

(72) Inventors: Koichi IMANAKA, Osaka (JP); Koju YAMAMOTO, Osaka (JP)

(73) Assignee: KYOCERA Document Solutions Inc., Osaka (JP)

(21) Appl. No.: 19/559,165

(22) Filed: Mar. 6, 2026

(30) Foreign Application Priority Data
Mar. 12, 2025 (JP) 2025-038922

(51) Int. Cl. G03G 21/16; G03G 15/00; G03G 15/08

(52) U.S. Cl. CPC G03G 21/1647; G03G 15/0865; G03G 15/5054; G03G 21/1633; G03G 2215/00059; G03G 2221/0005; G03G 2221/163; G03G 2221/1654; G03G 2221/1657

(57) ABSTRACT

An image forming apparatus includes a housing, a cover, a driving source, a joint, a driving lever, a sensor, a cleaning assembly, and an interlocking mechanism. The joint is movable between a coupling position of a driving member and a driving source and a decoupling position between the driving member and the driving source. The driving lever moves in one direction and the opposite direction to move the joint to the coupling position and the decoupling position. The interlocking mechanism causes the cleaning assembly to clean a detection surface of the sensor and moves the driving lever from the coupling position to the decoupling position in accordance with an opening operation of the cover, and causes the cleaning assembly to clean the detection surface of the sensor and moves the driving lever from the decoupling position to the coupling position in accordance with a closing operation of the cover.

### INCORPORATION BY REFERENCE

This application is based on and claims the benefit of priority from Japanese patent application No. 2025-038922 filed on Mar. 12, 2025, which is incorporated by reference in its entirety.

### BACKGROUND

The present disclosure relates to an image forming apparatus including a toner container having a driving member and an openable/closable cover.

In an image forming apparatus such as a printer or a multifunctional peripheral, when a toner container is attached to a housing, a driving member provided in the toner container may be connected to a driving source provided in the housing so that a driving force is transmitted from the driving source to the driving member. For example, the image forming apparatus includes a joint movable between a position coupling the driving member and the driving source and to a position decoupling between the driving member and the driving source. The joint moves from the decoupling position to the coupling position in accordance with the operation of attaching the toner container.

### SUMMARY

An image forming apparatus according to the present disclosure includes a housing, a cover, a driving source, a joint, a driving lever, a sensor, a cleaning assembly, and an interlocking mechanism. The housing houses a toner container including a driving member and an image carrier on which a toner image is carried. The cover is openably and closably provided on the housing and allows the toner container to be attached to and detached from the housing when the cover is opened. The driving source is disposed in the housing and coupled to the driving member to apply a driving force to the driving member. The joint is provided between the driving member and the driving source and movable between a coupling position of the driving member and the driving source and a decoupling position between the driving member and the driving source. The driving lever moves in one direction and the opposite direction to move the joint to the coupling position and the decoupling position. The sensor is disposed in the housing and detects a density of the toner image carried on the image carrier. The cleaning assembly cleans a detection surface of the sensor. The interlocking mechanism is provided between the cover, the cleaning assembly and the driving lever, causes the cleaning assembly to clean the detection surface of the sensor and moves the driving lever from the coupling position to the decoupling position in accordance with an opening operation of the cover, and causes the cleaning assembly to clean the detection surface of the sensor and moves the driving lever from the decoupling position to the coupling position in accordance with a closing operation of the cover.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a side view schematically showing an internal structure of the image forming apparatus according to the embodiment of the present disclosure.

FIG. 3 is a perspective view schematically showing a transmission mechanism of the image forming apparatus according to the embodiment of the present disclosure.

FIG. 4 is a cross-sectional view showing the transmission mechanism of the image forming apparatus according to an embodiment of the present disclosure.

FIG. 5 is a perspective view showing a holding case and a joint of the transmission mechanism in an image forming apparatus according to the embodiment of the present disclosure.

FIG. 6 is a perspective view showing an optical sensor and a cleaning assembly in the image forming apparatus according to the embodiment of the present disclosure.

FIG. 7 is an enlarged perspective view showing the optical sensor and the cleaning assembly in the image forming apparatus according to the embodiment of the present disclosure.

FIG. 8 is a perspective view showing an interlocking mechanism of the image forming apparatus according to the embodiment of the present disclosure.

FIG. 9 is a cross-sectional view showing the interlocking mechanism of the image forming apparatus according to the embodiment of the present disclosure.

FIG. 10 is a diagram schematically showing a cleaning operation of the sensor by the cleaning assembly in the image forming apparatus according to the embodiment of the present disclosure.

### DETAILED DESCRIPTION

Hereinafter, with reference to the drawings, an image forming apparatus according to one embodiment of the present disclosure will be described.

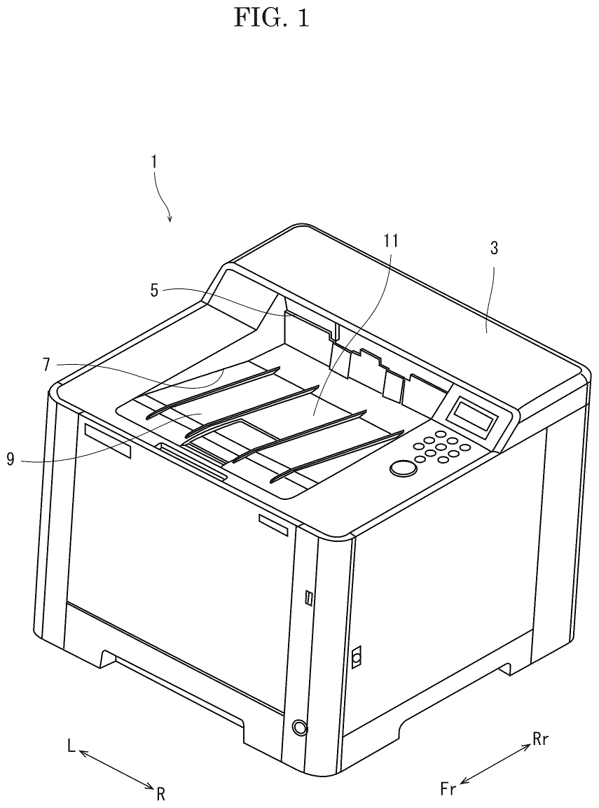

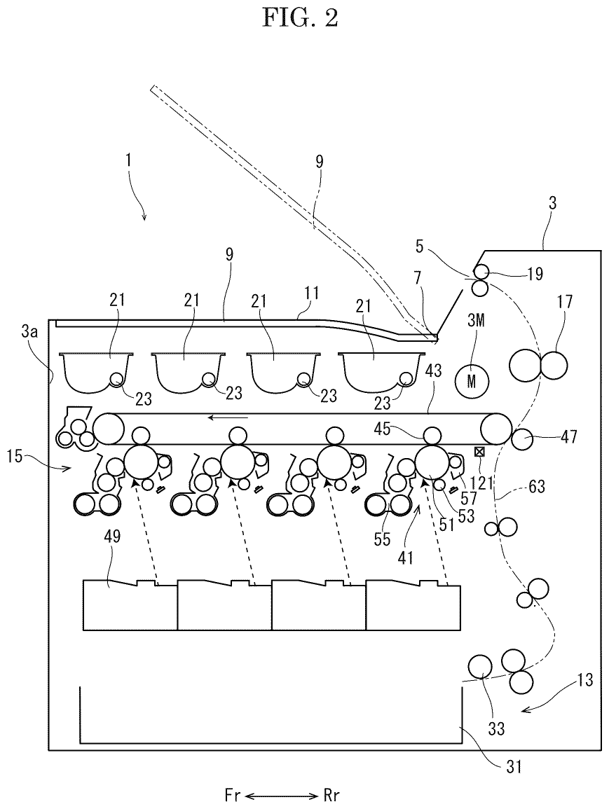

First, the entire configuration of the image forming apparatus 1 will be described with reference to FIG. 1 and FIG. 2. FIG. 1 is a perspective view showing the image forming apparatus 1, and FIG. 2 is a side view schematically showing the internal structure of the image forming apparatus 1. Reference numerals Fr, Rr, L, and R in the drawings indicate the front side, rear side, left side, and right side of the image forming apparatus 1, respectively.

As shown in FIG. 1, the image forming apparatus 1 includes a housing 3 having a rectangular parallelepiped shaped hollow space. In the upper plate of the housing 3, a discharge port 5 through which a sheet on which an image is formed by an image forming operation described later is discharged is formed. Further, a rectangular opening 7 is formed in the upper plate of the housing 3 in front of the discharge port 5. The opening 7 is opened and closed by a top cover 9. The top cover 9 is rotatably supported by the upper plate of the housing 3 on the rear side of the opening 7. On the upper surface of the top cover 9, a discharge tray 11 on which the sheets discharged through the discharge port 5 are stacked is formed. The top cover 9 is an example of the cover according to the present disclosure.

As shown in FIG. 2, in the hollow space of the housing 3, a sheet feeding part 13, an image forming part 15, a fixing part 17, a discharge part 19, and four toner containers 21 are housed.

The sheet feeding part 13 is disposed in the lower portion of the hollow space. The sheet feeding part 13 includes a sheet feeding cassette 31 in which the sheets are stored, and a sheet feeding device 33 which feeds the sheets stored in the sheet feeding cassette 31.

The image forming part 15 is disposed above the sheet feeding part 13. The image forming part 15 includes four image forming units 41 corresponding to toner of four colors (yellow, cyan, magenta, and black), an intermediate transfer belt 43, four primary transfer rollers 45 corresponding to the four image forming units 41, a secondary transfer roller 47, and an exposure device 49. Each image forming unit 41 is provided with a photosensitive drum 51 rotatable around a rotational axis, and a charging device 53, a developing device 55, and a cleaning device 57 which are arranged around the photosensitive drum 51. The four image forming units 41 are arranged side by side in the front-and-rear direction with the rotational axis of the photosensitive drum 51 aligned in the left-and-right direction.

The intermediate transfer belt 43 is disposed above the four image forming units 41. The intermediate transfer belt 43 is wound around a driven roller and a driving roller which are spaced apart in the front-and-rear direction, and travels in a direction indicated by the arrow in FIG. 2. The outer surface of the lower traveling path of the intermediate transfer belt 43 faces the photosensitive drums 51 of the four image forming units 41 and forms primary transfer nips between the photosensitive drums 51 and the intermediate transfer belt 43. The intermediate transfer belt 43 is an example of the image carrier according to the present disclosure. The four primary transfer rollers 45 are disposed in the inner hollow space of the intermediate transfer belt 43 and face the photosensitive drums 51 of the four image forming units 41 across the intermediate transfer belt 43. The secondary transfer roller 47 faces the driving roller across the intermediate transfer belt 43 and forms a secondary transfer nip between the secondary transfer roller 47 and the intermediate transfer belt 43. The exposure device 49 is disposed below the four image forming units 41.

The fixing part 17 is disposed above the secondary transfer nip. The fixing part 17 includes a heating roller and a pressure roller, and a fixing nip is formed between both rollers. The discharge part 19 is disposed inside the discharge port 5. The discharge part 19 includes a pair of discharge rollers.

The four toner containers 21 store the toner of four colors. The toner container 21 is provided with a toner discharge port (not shown). The toner container 21 accommodates a stirring paddle and a discharge screw (both are not shown), and a driving shaft 23 for rotating the stirring paddle and the discharge screw. The driving shaft 23 is an example of the driving member according to the present disclosure. The tip portion of the driving shaft 23 projects from one end of the toner container 21. A coupling part is formed at the projecting tip portion.

The four toner containers 21 are attached to a container housing part 3a side by side in the front-and-rear direction to correspond to the four image forming units 41. More specifically, the four toner containers 21 are detachably attached to the container housing part 3a provided above the intermediate transfer belt 43 in a posture in which the driving shaft 23 is aligned in the left-and-right direction and the coupling part is positioned on the left side. The toner container 21 is detachable from the container housing part 3a through the opening 7 of the upper plate of the housing 3. By opening the top cover 9, the container housing part 3a is opened, and the toner containers 21 can be attached and detached.

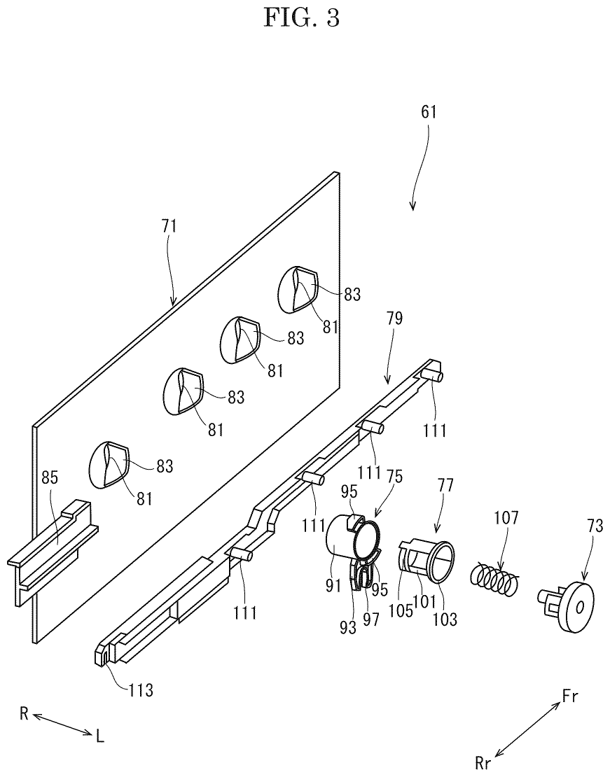

The container housing part 3a is formed between the left and right side plates of the housing 3. The container housing part 3a is provided with a toner supply pipe (not shown) and a transmission mechanism 61 (not shown in FIG. 1 and FIG. 2, and will be described later with reference to FIG. 3 to FIG. 6.) for each toner container 21. An opening corresponding to the driving shaft 23 is formed in the left side plate of the housing 3 for each toner container 21. The toner supply pipe is disposed between the toner discharge port of the attached toner container 21 and the developing device 55 corresponding to the toner container 21. The transmission mechanism 61 transmits a driving force from a driving source 3M disposed in the housing 3 to the driving shaft 23 of the attached toner container 21 and releases the transmission of the driving force. When the toner container 21 is attached to the container housing part 3a, the toner discharge port of the toner container 21 is connected to the toner supply pipe, and the driving shaft 23 is connected to the driving source 3M via the transmission mechanism 61.

In the hollow space of the housing 3, a sheet conveying path 63 is formed from the sheet feeding device 33 of the sheet feeding part 13 to the discharge port 5 through the secondary transfer nip, the fixing nip, and the discharge part 19.

The image forming operation will be briefly described. In each image forming unit 41 of the image forming part 15, the charging device 53 charges the photosensitive drum 51 to a predetermined potential. Thereafter, the photosensitive drum 51 is exposed by the exposure device 49 based on image data to form an electrostatic latent image. The electrostatic latent image is developed into a toner image by the developing device 55. The toner image is transferred from the photosensitive drum 51 to the intermediate transfer belt 43 by the primary transfer roller 45 at the primary transfer nip. A full-color toner image is formed on the intermediate transfer belt 43 by transferring the toner images to the intermediate transfer belt 43 in each of the four image forming units 41.

On the other hand, in the sheet feeding part 13, the sheet is fed from the sheet feeding cassette 31 to the conveying path 63 by the sheet feeding device 33. The sheet is conveyed along the conveying path 63 and conveyed to the secondary transfer nip. In the secondary transfer nip, the full-color toner image is transferred from the intermediate transfer belt 43 to the sheet by the secondary transfer roller 47. Thereafter, the sheet is conveyed to the fixing part 17, and the toner image is heated and pressurized in the fixing nip to be fixed to the sheet. The sheet is conveyed to the discharge part 19 and discharged to the discharge tray 11 through the discharge port 5 by the pair of discharge rollers.

When an amount of the toner in the developing device 55 decreases, the driving shaft 23 of the corresponding toner container 21 is driven to rotate the stirring paddle and the discharge screw, and the toner is replenished from the toner container 21 to the developing device 55 through the toner supply pipe.

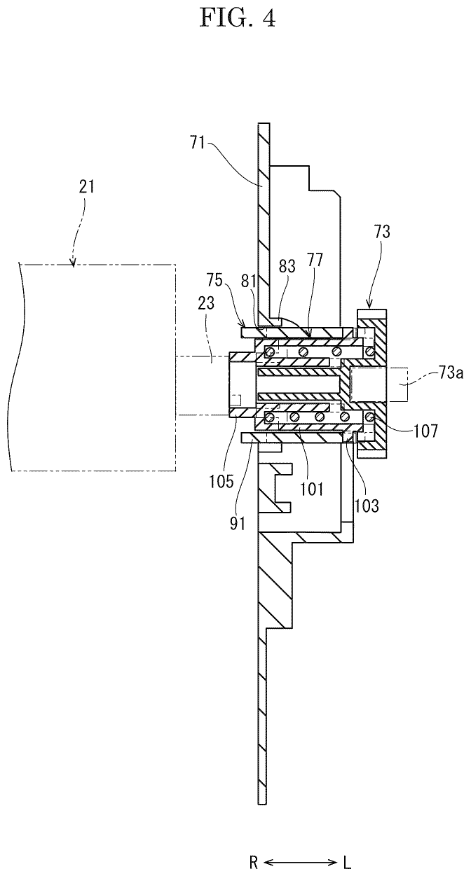

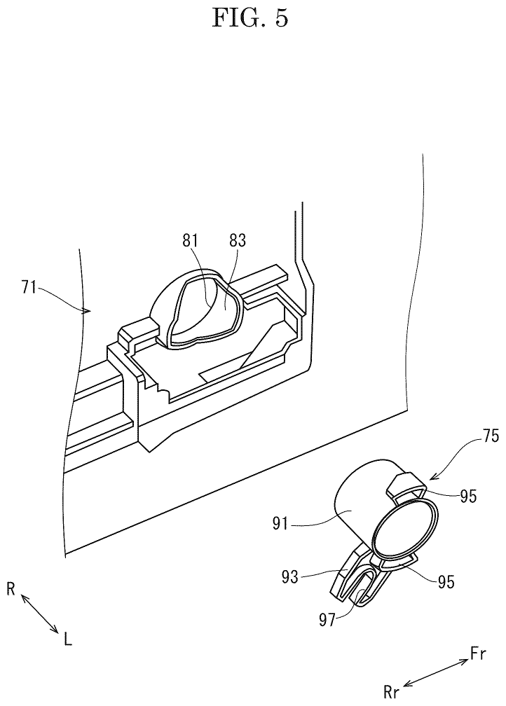

Next, the transmission mechanism 61 will be described with reference to FIG. 3 to FIG. 6. FIG. 3 is a perspective view showing the transmission mechanism 61, FIG. 4 is a sectional view showing a part of the transmission mechanism 61, and FIG. 5 is a perspective view showing a holding case 71 and a joint 75 of the transmission mechanism 61. As described above, the transmission mechanism 61 transmits the driving force from the driving source 3M to the driving shaft 23 of the toner container 21 and releases the transmission of the driving force. As shown in FIG. 3, the transmission mechanism 61 includes a holding case 71 supported by the left side plate of the housing 3, a driving gear 73 provided for each of the four toner containers 21, a joint 75 provided for each of the four toner containers 21, a coupling 77 supported by each joint 75, and a driving lever 79 for rotating the four joints 75.

First, the holding case 71 will be described. The holding case 71 is formed with four circular openings 81 corresponding to the four openings formed on the left side plate. In the following description, with respect to the left side plate, the inner side (on the side of the container housing part 3a) of the housing 3 is defined as the inside and the opposite side is defined as the outside. A cylindrical peripheral wall 83 is formed on the outside surface of the holding case 71 along the periphery of the opening 81. A height of the peripheral wall 83 (a height from the outside surface of the holding case 71) varies along the circumferential direction. Rails 85 (the rail formed on the inner surface is not shown) extending in the front-and-rear direction are formed on the outside surface and the inside surface of the holding case 71 below the openings 81. The holding case 71 is supported on the outside surface of the left side plate.

Next, the driving gear 73 will be described. As shown in FIG. 4, the driving gear 73 is supported by a support plate (not shown) provided outside the holding case 71 in a rotatable manner around a rotational shaft 73a. The rotational shaft 73a is disposed coaxially with the center of the opening 81 of the holding case 71. The driving gear 73 is connected to the driving source 3M through a gear train or the like.

Next, the joint 75 will be described. As clearly shown in FIG. 5, the joint 75 has a cylindrical portion 91 that can be inserted into the peripheral wall 83 of the holding case 71, an arm portion 93 provided radially from the outer surface of the cylindrical portion 91, and two projections 95 projecting radially from the outer surface of the cylindrical portion 91. The arm portion 93 has a groove 97 along the longitudinal direction. When the cylindrical portion 91 is inserted into the peripheral wall 83 of the holding case 71, the two projections 95 abut on the end surface of the peripheral wall 83. As the joint 75 rotates within the peripheral wall 83, the two projections 95 are guided along the end surface of the peripheral wall 83 to move the joint 75 inwardly and outwardly.

Next, the coupling 77 will be described. As shown in FIG. 3 and FIG. 4, the coupling 77 has a cylindrical portion 101 that can be inserted into the cylindrical portion 91 of the joint 75, a flange portion 103 provided at one end of the cylindrical portion 101, and a coupling portion 105 provided at the other end of the cylindrical portion 101. An outer diameter of the flange portion 103 is larger than the outer diameter of the cylindrical portion 91 of the joint 75. The coupling portion 105 can be coupled to the coupling part of the driving shaft 23 of the toner container 21.

The cylindrical portion 101 of the coupling 77 is inserted into the cylindrical portion 91 of the joint 75 with the coupling portion 105 forward. Further, the coupling 77 is coupled to the driving gear 73 so as to be rotatable together with the driving gear 73 and be axially movable with respect to the driving gear 73. A coil spring 107 is arranged between the driving gear 73 and the coupling 77. The coil spring 107 biases the coupling 77 inwardly with respect to the driving gear 73.

Next, the driving lever 79 will be described. As shown in FIG. 3, the driving lever 79 has four bosses 111 and a hook 113. The four bosses 111 are arranged on one side surface of the driving lever 79 at predetermined intervals. The hook 113 is formed at one end of the driving lever 79. The driving lever 79 is movably supported by the rail 85 formed on the outside surface of the holding case 71 in such a posture that the four bosses 111 face outward and the hook 113 faces rearward. The four bosses 111 are inserted into the grooves 97 of the arm portions 93 of the four joints 75. When the driving lever 79 is moved in one direction and the other direction, the arm portions 93 of the joints 75 are pushed by the bosses 111, and the joints 75 rotate in one direction and the other direction. Specifically, when the driving lever 79 is moved rearward, the joints 75 rotates in the clockwise direction in FIG. 3, and when the driving lever 79 is moved forward, the joints75 rotates in the counterclockwise direction in FIG. 3.

In a state where the projections 95 of the joint 75 are in contact with the lowest end surfaces of the peripheral wall 83 of the holding case 71, the coupling 77 is biased inwardly by the coil spring 107. As shown in FIG. 4, when the coupling 77 is biased inwardly until the flange portion 103 abuts on the end surface of the cylindrical portion 91, the coupling portion 105 projects into the container housing part 3a through the cylindrical portion 91 of the joint 75, the opening of the left side plate (not shown in FIG. 4) and the opening 81 of the holding case 71. As a result, the joint part of the driving shaft 23 of the toner container 21 attached to the container housing part 3a is coupled to the coupling portion 105. When the driving source 3M is driven and the driving gear 73 rotates in such a state that the driving shaft 23 and the joint 75 are coupled, the driving shaft 23 rotates via the joint 75, and the stirring paddle and the conveying screw rotate. That is, the driving force of the driving source 3M is transmitted to the driving shaft 23. This enables agitation and conveyance of the toner in the toner container 21.

When the driving lever 79 is moved forward, the joint 75 rotates, the projections 95 rides up on the peripheral wall 83, and the joint 75 moves outward while rotating. Then, the flange portion 103 of the coupling 77 is pressed by the joint 75, and the coupling 77 moves outward against the biasing force of the coil spring 107. Since the rotation of the coupling 77 is restricted by the driving gear 73, the coupling 77 moves outwardly while remaining in the same posture. As a result, the coupling portion 105 is separated from the coupling part of the driving shaft 23 and retracted from the container housing part 3a. This releases the transmission of the driving force from the driving source 3M to the driving shaft 23. In this manner, the joint 75 is moved by the movement of the driving lever 79 to a coupling position where the coupling portion 105 projects into the container housing part 3a and a decoupling position where the coupling portion 105 retreats from the container housing part 3a.

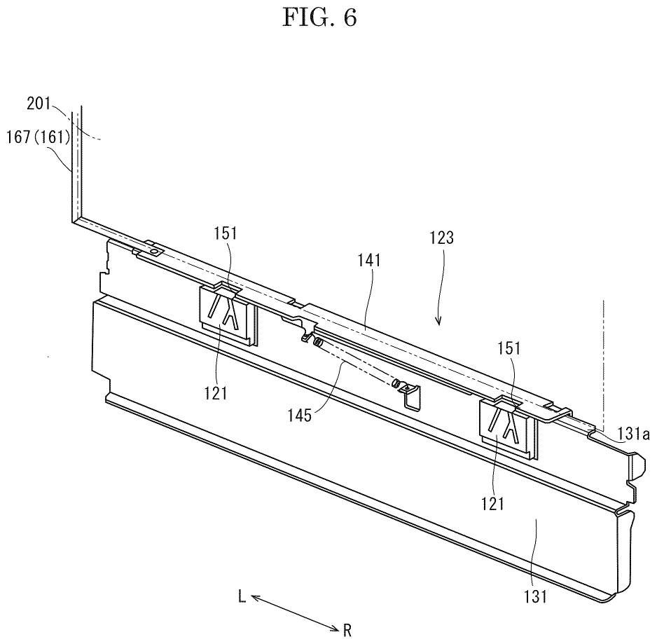

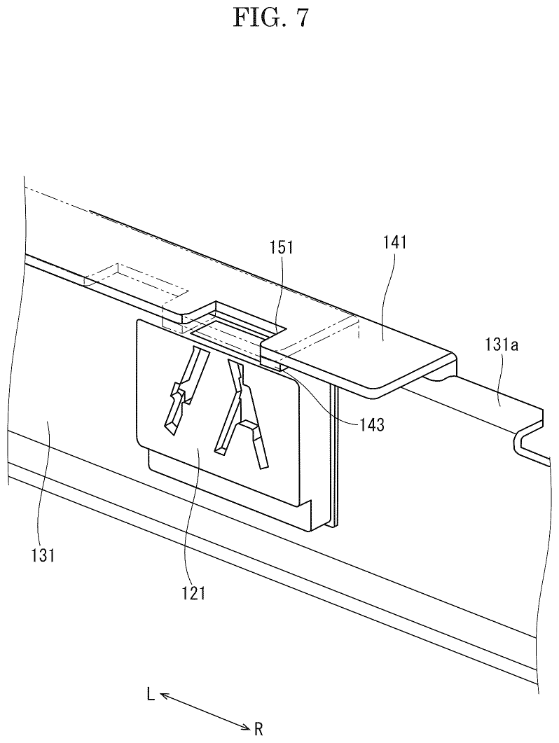

Further, as shown in FIG. 6 and FIG. 7, in the hollow space of the housing 3, two optical sensors 121 and a cleaning assembly 123 are provided. The optical sensor 121 detects a density of the toner image formed on the intermediate transfer belt 43 by the above-described image forming operation. The cleaning assembly 123 cleans the detection surfaces of the optical sensors 121. FIG. 6 is a perspective view showing the optical sensor 121 and the cleaning assembly 123, and FIG. 7 is a perspective view showing the cleaning assembly 123.

First, the optical sensor 121 will be described. The two optical sensors 121 are supported by a support plate 131. The support plate 131 is disposed along the width direction of the intermediate transfer belt 43 (the left-and-right direction) on the upstream side of the secondary transfer nip in the traveling direction of the intermediate transfer belt 43. The support plate 131 has a bent piece 131a bent rearward along the upper edge.

The two optical sensors 121 are supported on the upper end portion of the front surface of the support plate 131 at an interval in the left-and-right direction. As shown in FIG. 2, the detection surface of the optical sensor 121 faces the lower traveling surface of the intermediate transfer belt 43.

Next, the cleaning assembly 123 will be described. The cleaning assembly 123 includes a movable plate 141 movably supported by the support plate 131, a cleaning member 143 (see FIG. 7) fixed to the movable plate 141, and a coil spring 145 disposed between the movable plate 141 and the support plate 131.

The movable plate 141 has a length slightly shorter than the length of the support plate 131 in the left-and-right direction. The movable plate 141 has two openings 151 with an interval equal to the interval between the two optical sensors 121. The movable plate 141 is engaged with the bent piece 131a of the support plate 131, and is movable in the left-and-right direction along the bent piece 131a. At this time, there is a space between the lower surface of the movable plate 141 and the detection surface of the optical sensor 121.

The cleaning member 143 is made of resin or fiber. The cleaning member 143 is fixed on the lower surface of the movable plate 141 along the side edge of each opening 151 of the movable plate 141. More specifically, as shown in FIG. 7, the cleaning member 143 is fixed on the lower surface of the movable plate 141 along the right side edge of each opening 151 and is capable of being in contact with the detection surface of the optical sensor 121. When the movable plate 141 moves leftward and rightward, the cleaning members 143 move leftward and rightward while in contact with the detection surfaces. Thus, the detection surfaces are cleaned by the cleaning members 143.

As shown in FIG. 6, one end of the coil spring 145 is fixed to the substantially central portion of the movable plate 141, and the other end is fixed to the front surface of the support plate 131. When the coil spring 145 is not extended (see FIG. 6), the detection surfaces of the two optical sensors 121 are exposed from the two openings 151 of the movable plate 141, and the density of the toner image can be read by the optical sensor 121. Each cleaning member 143 is located on the right side of the detection surface. The position of the movable plate 141 at this time is set to an initial position.

When the movable plate 141 is moved leftward against the biasing force of the coil spring 145, the cleaning members 143 move along the detection surfaces of the optical sensors 121 to clean the detection surfaces. When the movable plate 141 is released thereafter, the movable plate 141 is biased by the coil spring 145 and returns to the initial position. Also at this time, the cleaning members 143 move along the detection surfaces of the optical sensors 121 to clean the detection surfaces. By moving the movable plate 141 in the left-and-right direction in this manner, the detection surfaces of the optical sensors 121 are cleaned. In this example, the left direction is one direction in the present disclosure, and the right direction is the opposite direction in the present disclosure. When the movable plate 141 is biased by the coil spring 145, the movable plate 141 stops at the initial position.

Further, the housing 3 includes an interlocking mechanism provided between the top cover 9, and the cleaning assembly 123 and the driving lever 79 of the transmission mechanism 61. The interlocking mechanism causes the cleaning assembly 123 to clean the detection surfaces of the optical sensors 121 and moves the driving lever 79 to move the coupling 77 from the coupling position to the decoupling position, in accordance with the opening operation of the top cover 9. The interlocking mechanism causes the cleaning assembly 123 to clean the detection surfaces of the optical sensors 121 and moves the driving lever 79 to move the coupling 77 from the decoupling position to the coupling position, in accordance with the closing operation of the top cover 9.

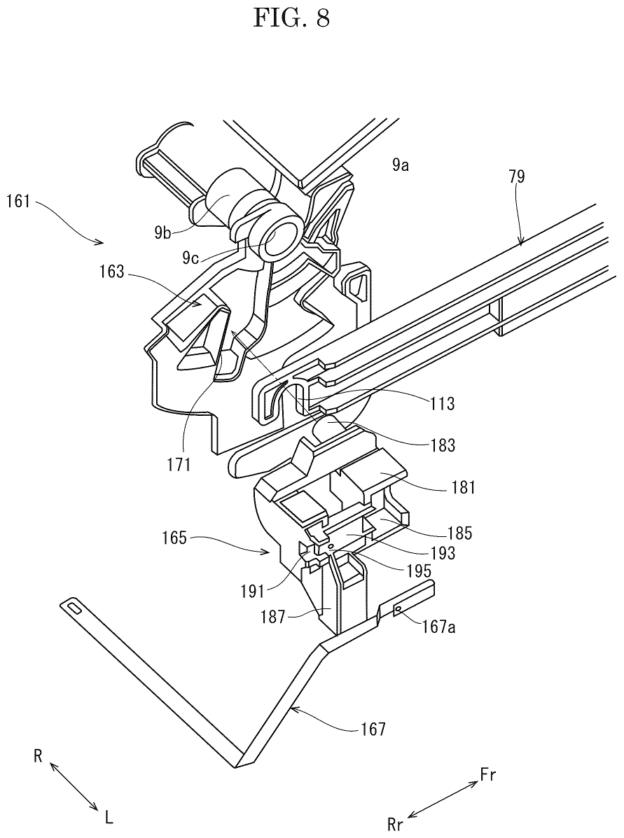

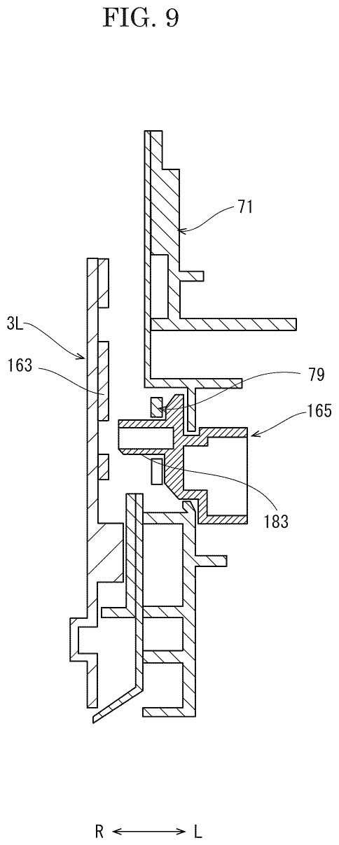

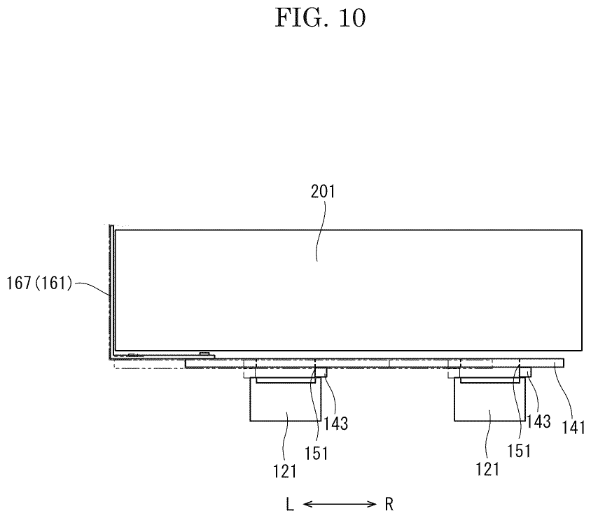

The interlocking mechanism 161 will be described with reference to FIG. 8 to FIG. 10. FIG. 8 is a perspective view showing the interlocking mechanism 161, FIG. 9 is a sectional view showing the interlocking mechanism 161, and FIG. 10 is a rear view showing the cleaning assembly 123 and a belt-shaped member 167. As shown in FIG. 8, the interlocking mechanism 161 includes a rotating part 163 provided on the top cover 9, a slider 165 supported by the holding case 71 of the transmission mechanism 61, and a non-elastic and plastic belt-shaped member 167 disposed between the slider 165 and the cleaning assembly 123.

First, the rotating part 163 will be described. First, the overall structure of the top cover 9 will be described. The top cover 9 has a cover plate 9a and bearing portions 9b provided at left and right rear corners of the cover plate 9a. The bearing portion 9b has a shaft hole 9c extending in the left-and-right direction. A rotational shaft provided in the housing 3 is inserted into the shaft holes 9c. As a result, the top cover 9 is turned around the rotational shafts to open and close the opening 7.

The rotating part 163 is formed in a substantially fan shape around the shaft hole 9c of the left bearing portion 9b of the top cover 9. On the outside surface of the rotating part 163, a groove 171 along a direction passing through the center of the shaft hole 9c is formed. As shown in FIG. 9, the rotating part 163 is disposed outside the left side plate 3L of the housing 3.

Next, the slider 165 will be described. As shown in FIG. 9, the slider 165 is supported between the left side plate 3L of the housing 3 and the holding case 71 of the transmission mechanism 61, and is disposed outside the driving lever 79. As shown in FIG. 8, the slider 165 is a member having a substantially rectangular parallelepiped shape, and has a rail portion 181, a boss 183 provided inside the rail portion 181, and a connecting portion 185 and a handle 187 provided outside the rail portion 181. The rail portion 181 is engaged with a rail formed on the inside surface of the holding case 71. Thus, the slider 165 is movable in the front-and-rear direction along the rail.

The boss 183 projects inwardly. The boss 183 is inserted into the groove 171 of the rotating part 163 of the top cover 9 in a state in which the top cover 9 is turned in a posture in which the opening 7 is closed. Further, the hook 113 of the driving lever 79 is engaged with the boss 183 (see the arrow in FIG. 8). When the top cover 9 is opened, the rotating part 163 rotates in the counterclockwise direction in FIG. 8. The boss 183 inserted into the groove 171 of the rotating part 163 is pushed by the side edge of the groove 171 and moves forward while moving in the groove 171. By moving the boss 183 forward in this way, the hook 113 is pushed by the boss 183, and the driving lever 79 also moves forward.

On the other hand, when the top cover 9 is closed, the rotating part 163 rotates in the clockwise direction in FIG. 8, and the boss 183 inserted into the groove 171 of the rotating part 163 moves rearward. As the boss 183 moves rearward in this manner, the driving lever 79 also moves rearward. In this manner, the driving lever 79 moves forward and rearward together with the slider 165 in accordance with the opening and closing operation of the top cover 9.

The connecting portion 185 has a through-hole 191 extending in the front-and-rear direction and a flat portion 193 provided outside the through-hole 191. A boss 195 is erected on the flat portion 193. The handle 187 is provided below the connecting portion 185.

Next, the belt-shaped member 167 will be described. The belt-shaped member 167 is made of non-elastic and plastic material (for example, PET film). One end of the belt-shaped member 167 is connected to the connecting portion 185 of the slider 165. More specifically, as shown in FIG. 8, an opening 167a is formed at one end portion of the belt-shaped member 167. The one end portion is inserted into the through-hole 191 of the connecting portion 185 from the rear side, folded back outward and rearward, and the boss 195 formed in the flat portion 193 is inserted into the opening 167a formed in the one end portion. The folded end portion is fixed to the flat portion 193 with a double-sided tape. The other end of the belt-shaped member 167 is fixed to the left end of the movable plate 141 of the cleaning assembly 123, as shown in FIG. 6.

In a state in which the slider 165 is moved rearmost and the movable plate 141 of the cleaning assembly 123 is moved to the initial position, the belt-shaped member 167 is wired along a predetermined wiring path without slack. As shown in FIG. 6, in this example, the wiring path is an L-shaped path along the lower left corner of a rectangular plate 201 provided above the support plate 131.

In the image forming apparatus 1 having the above configuration, the transmission and transmission release operations of the driving force by the transmission mechanism 61 and the cleaning operation of the sensors 121 by the cleaning assembly 123 in accordance with the opening and closing operation of the top cover 9 will be described with reference to the above drawings. When the top cover 9 is closed, the slider 165 of the interlocking mechanism 161 moves rearmost. That is, the driving lever 79 of the transmission mechanism 61 also moves rearmost so that the projections 95 of the joint 75 abuts against the lowest end surfaces of the peripheral wall 83 of the holding case 71. As shown in FIG. 4, the coupling 77 is biased inwardly by the coil spring 107 and moved to the coupling position. The coupling portion 105 is coupled to the coupling part of the driving shaft 23 of the toner container 21 attached to the container housing part 3a, so that the driving force of the driving source 3M can be transmitted to the driving shaft 23.

Further, as shown in FIG. 6, the movable plate 141 of the cleaning assembly 123 is moved to the initial position. That is, the detection surfaces of the sensors 121 are exposed through the openings 151 of the movable plate 141, and the toner density can be detected by the sensors 121. The cleaning members 143 are located on the right side of the detection surfaces.

When the top cover 9 is opened, the rotating part 163 rotates in the counterclockwise direction in FIG. 8, and the driving lever 79 moves forward together with the slider 165 as described above. As a result, the joint 75 moves outward while rotating in the counterclockwise direction, the coupling portion 105 of the coupling 77 separates from the driving shaft 23, and the coupling 77 moves to the decoupling position.

Further, as shown in FIG. 10, the movable plate 141 of the cleaning assembly 123 is pulled by the belt-shaped member 167 and moves leftward against the biasing force of the coil spring 145. The belt-shaped member 167 moves along the predetermined wiring path without slack. As the movable plate 141 moves in this manner, the cleaning members 143 move along the detection surfaces of the sensors 121, and the detection surfaces are cleaned.

When the top cover 9 is opened, the toner container 21 can be detached. At this time, since the coupling 77 and the joint 75 of the transmission mechanism 61 are retracted from the container housing part 3a, the toner container 21 and the coupling 77 do not interfere with each other.

When the top cover 9 is closed after the attaching of the new toner container 21 is completed, the rotating part 163 rotates in the clockwise direction in FIG. 8, and the driving lever 79 moves rearward together with the slider 165. Thereby, the joint 75 moves inwardly while rotating, and the coupling 77 is moved to the coupling position. As a result, the coupling portion 105 of the coupling 77 is coupled to the coupling part of the driving shaft 23 of the attached toner container 21, and the driving force of the driving source 3M can be transmitted to the driving shaft 23.

Further, the movable plate 141 of the cleaning assembly 123 to which the other end of the belt-shaped member 167 is fixed is pulled by the coil spring 145 and moves rightward. Thus, the cleaning members 143 move along the detection surfaces of the sensors 121, and the detection surfaces are cleaned. In this case, the belt-shaped member 167 moves along the wiring path without slack.

As described above, in the image forming apparatus 1 of the present disclosure, the opening/closing operation of the top cover 9 can be interlocked with the transmission and transmission release operation of the driving force by the transmission mechanism 61 and the cleaning operation of the sensors 121 by the cleaning assembly 123. That is, when the top cover 9 is opened, the coupling between the toner container 21 and the driving source 3M is released, and when the top cover 9 is closed, the toner container 21 is coupled to the driving source 3M. Therefore, a dedicated operation for coupling and decoupling between the toner container 21 and the driving source 3M is not required, and workability is improved. Further, since the detection surfaces of the sensor 121 can be cleaned by opening and closing the top cover 9, a dedicated operation for cleaning the sensors 121 is not required, and maintainability is improved. As a result, the number of parts can be reduced and the cost can be reduced.

When the coupling 77 of the transmission mechanism 61 is moved to the decoupling position, the coupling 77 and the joint 75 are retracted from the container housing part 3a, so that the toner container 21 does not interfere with the coupling 77 when the toner container 21 is attached or detached. When the top cover 9 is half-opened, the coupling 77 does not completely retract from the container housing part 3a. This makes it impossible to attach/detach the toner container 21.

The belt-shaped member 167 of the interlocking mechanism 161 moves along the predetermined wiring path when the slider 165 moves. Since the movable plate 141 of the cleaning assembly 123 to which the belt-shaped member 167 is connected is biased to the initial position by the coil spring 145, the belt-shaped member 167 is always wired along the wiring path without slack. Therefore, the belt-shaped member 167 can be surely moved by the movement of the slider 165.

The slider 165 of the interlocking mechanism 161 may be omitted, and the driving lever 79 and the belt-shaped member 167 may be directly connected to the rotating part 163 of the top cover 9. However, since the space for accommodating them is very small, it is preferable to operate the driving lever 79 and the belt-shaped member 167 through the slider 165 in consideration of the assembling efficiency of the interlocking mechanism 161. For example, after opening the top cover 9 and moving the driving lever 79 rearmost to position the rotating part 163 and the driving lever 79, the handle 187 of the slider 165 to which the belt-shaped member 167 is fixed is held to engage the boss 183 with the hook 113 of the driving lever 79 and the groove 171 of the rotating part 163.

Further, since the above description of the embodiments of the present disclosure is a description of the preferred embodiments of the image forming apparatus according to the present disclosure, various technically preferable limitations are attached in some cases, but the technical scope of the present disclosure is not limited to these embodiments unless the description specifically limits the present disclosure.

What is claimed is:

1. An image forming apparatus comprising:
a housing which houses a toner container including a driving member and an image carrier on which a toner image is carried;
a cover which is openably and closably provided on the housing and allows the toner container to be attached to and detached from the housing when the cover is opened;
a driving source which is disposed in the housing and coupled to the driving member to apply a driving force to the driving member;
a joint which is provided between the driving member and the driving source and movable between a coupling position of the driving member and the driving source and a decoupling position between the driving member and the driving source;
a driving lever which moves in one direction and the opposite direction to move the joint to the coupling position and the decoupling position;
a sensor which is disposed in the housing and detects a density of the toner image carried on the image carrier;
a cleaning assembly which cleans a detection surface of the sensor; and
an interlocking mechanism which is provided between the cover, the cleaning assembly and the driving lever, causes the cleaning assembly to clean the detection surface of the sensor and moves the driving lever from the coupling position to the decoupling position in accordance with an opening operation of the cover, and causes the cleaning assembly to clean the detection surface of the sensor and moves the driving lever from the decoupling position to the coupling position in accordance with a closing operation of the cover.

2. The image forming apparatus according to claim 1, wherein
the cleaning assembly includes:
a movable plate which is movable in one direction and the opposite direction;
a cleaning member which fixed to the movable plate and brought into contact with the detection surface of the sensor by movement of the movable plate; and
a biasing member which biases the movable plate so as to move in the opposite direction.

3. The image forming apparatus according to claim 2, wherein
the interlocking mechanism includes:
a rotating portion which is provided around a rotational shaft of the cover and has a groove formed along a direction passing through a center of the rotational shaft;
a slider which is supported in the housing in a movable manner along a moving direction of the driving lever, and has a boss inserted into the groove and with which one end of the driving lever is engaged; and
a non-elastic and plastic belt-shaped member which is disposed between the slider and the movable plate of the cleaning assembly, wherein
the slider moves with the opening operation of the cover to move the movable plate in one direction against the biasing force of the biasing member through the belt-shaped member, and the slider moves with the closing operation of the cover to move the movable plate in opposite direction by the biasing member.

4. The image forming apparatus according to claim 3, wherein
when the slider is moved, the belt-shaped member moves along a fixed wiring path.

5. The image forming apparatus according to claim 2, wherein
the interlocking mechanism includes:
a rotating portion which is provided around a rotational shaft of the cover and to which one end of the driving lever is coupled; and
a non-elastic and plastic belt-shaped member which is disposed between the rotating portion and the movable plate of the cleaning assembly, wherein
the movable plate is moved in one direction through the bel-shaped member against the biasing force of the biasing member with the opening operation of the cover, and the movable plate is moved in the opposite direction by the biasing member with the closing operation of the cover.
